(19) United States
(12) Patent Application Publication
(10) Pub. No.: US 2014/0185327 A1
(43) Pub. Date: Jul. 3, 2014

(54) HIGH POWER DENSITY OFF-LINE POWER SUPPLY

(71) Applicant: AVOGY, INC, San Jose, CA (US)

(72) Inventor: Hemal N. Shah, San Mateo, CA (US)

(73) Assignee: AVOGY, INC, San Jose, CA (US)

(21) Appl. No.: 13/731,872

(22) Filed: Dec. 31, 2012

(51) Int. Cl. H02M 7/217; H02M 3/335

(52) U.S. Cl. CPC H02M 7/217; H02M 3/335
USPC 363/16

(57) ABSTRACT

A power supply is provided, the power supply including a filter stage configured to receive an AC input voltage, a bridge circuit configured to rectify the filtered AC input voltage, an AC/DC converter, and a DC/DC converter. The AC/DC converter includes a primary transistor and an auxiliary circuit including an auxiliary transistor and configured to convert the rectified AC input voltage to a first DC output voltage, wherein the primary transistor and the auxiliary transistor are at least one of gallium nitride (GaN) transistors or silicon carbide (SiC) transistors. The DC/DC converter is configured to convert the first DC output voltage to a second DC output voltage.

### BACKGROUND OF THE INVENTION

Power electronics are widely used in a variety of applications. Power electronic devices are commonly used in circuits to modify the form of electrical energy, for example, from alternating current (AC) to direct current (DC), from one voltage level to another, or in some other way. Such devices can operate over a wide range of power levels, from milliwatts in mobile devices to hundreds of megawatts in a high voltage power transmission system. Despite the progress made in power electronics, there is a need in the art for improved electronics systems and methods of operating the same.

### SUMMARY OF THE INVENTION

The present invention relates generally to methods and systems for providing power to electronic devices. More specifically, the present invention relates to an AC/DC power adapter with a power density capability of >50 W/in³. Embodiments of the present invention are applicable to a wide variety of power electronics including power supplies for various electronic devices and applications, power converters, and the like.

According to an embodiment of the present invention, a power supply is provided. The power supply includes a filter stage configured to receive an AC input voltage, a bridge circuit configured to rectify the filtered AC input voltage, an AC/DC converter, and a DC/DC converter. The AC/DC converter includes a primary transistor and an auxiliary circuit including an auxiliary transistor and configured to convert the rectified AC input voltage to a first DC output voltage, wherein the primary transistor and the auxiliary transistor are at least one of gallium nitride (GaN) transistors or silicon carbide (SiC) transistors. The DC/DC converter is configured to convert the first DC output voltage to a second DC output voltage.

According to another embodiment of the present invention, a method of providing a DC voltage is provided. The method includes receiving an AC input voltage, filtering the AC input voltage using an electromagnetic interference (EMI) filter, and rectifying the filtered AC input voltage. The rectified AC input voltage is then converted to a first DC output voltage using an AC/DC converter having a primary transistor and an auxiliary circuit, wherein the auxiliary circuit includes an auxiliary transistor and wherein the primary transistor and the auxiliary transistor are at least one of gallium nitride (GaN) or silicon carbide (SiC) transistors. The method further includes converting the first DC output voltage to a second DC output voltage using a DC/DC converter.

Embodiments of the invention provide a number of benefits and advantages over conventional techniques and power adapters. For example, embodiments of the present invention decrease the physical size of the power adapter in order to make it more convenient to carry. The weight of the power adapter is also reduced, increasing its portability, and applicability in mobile device applications. Another advantage provided by embodiments of the invention is a reduction in the heat dissipated by the power adapter, thereby improving the efficiency, performance, and resulting in cooler operation of the power adapter. Some embodiments of the present invention achieve an increase in power density through using a combination of advanced circuit topologies and state-of-the-art power devices made from GaN materials. These and other embodiments of the invention, along with many of its advantages and features, are described in more detail in conjunction with the text below and attached figures.

### BRIEF DESCRIPTION OF THE DRAWINGS

FIG. 1 is a simplified schematic diagram of a power adapter according to an embodiment of the invention.

FIGS. 2A-2B are simplified graphs illustrating a rectified analog signal.

FIG. 3 is a simplified schematic diagram of an AC/DC converter according to an embodiment of the invention.

FIGS. 4A-4D are simplified graphs illustrating operation of the AC/DC converter according to an embodiment of the invention.

FIG. 5 is a simplified schematic diagram of a DC/DC converter according to an embodiment of the invention.

FIG. 6 is a simplified flowchart illustrating a method of providing power to electronic devices according to an embodiment of the invention.

### DETAILED DESCRIPTION OF SPECIFIC EMBODIMENTS

The present invention relates generally to methods and systems for providing power to electronic devices. More specifically, the present invention relates to an AC/DC power adapter with a power density capability of >50 W/in³. Embodiments of the present invention are applicable to a wide variety of power electronics including power supplies for various electronic devices and applications, power converters, and the like.

The growing popularity of laptop computers and other portable electronic devices for use at home, office, and in-transit for both work and leisure in the recent years has created a trend of size and weight reduction of electronic devices and power adapters that are used to charge them. Conventional power adapters available today that are provided with typical laptop computers are bulky, heavy, and cumbersome to carry around, and therefore are not as portable as the consumer devices they are intended to charge. Typical full-size power adapters typically are about 85-90 W in output and the best in class power density available is about 17 W/in³. Despite progress made in miniaturizing portable consumer electronics, there is a need in the art for improved power adapter devices and methods of charging the portable consumer devices with optimal performance and minimized size, weight, and portability.

Conventional power adapters and other electronics generally are silicon-based. However, GaN-based electronic devices are undergoing rapid development, and generally are expected to outperform competitors in silicon (Si) and silicon carbide (SiC). Desirable properties associated with GaN and related alloys and heterostructures include high bandgap energy for visible and ultraviolet light emission, favorable transport properties (e.g., high electron mobility and saturation velocity), a high breakdown field, and high thermal conductivity. In particular, electron mobility, μ, is higher than competing materials for a given background doping level, N. This provides low resistivity, ρ, because resistivity is inversely proportional to electron mobility, as provided by equation (1):

$$ρ = \frac{1}{q μ N} , \qquad ( 1 )$$

where q is the elementary charge.

Another superior property provided by GaN materials, including homoepitaxial GaN layers on bulk GaN substrates, is high critical electric field for avalanche breakdown. A high critical electric field allows a larger voltage to be supported over smaller length, L, than a material with a lower critical electric field. A smaller length for current to flow together with low resistivity give rise to a lower resistance, R, than other materials, since resistance can be determined by equation (2):

$$R = \frac{ρ L}{A} , \qquad ( 2 )$$

where A is the cross-sectional area of the channel or current path.

These superior properties of GaN can give rise to improved semiconductor devices, including vertical semiconductor devices. Traditional semiconductor devices are typically lateral devices that utilize only the top side of a semiconductor wafer, locating electrical contacts such that electricity travels laterally along the semiconductor surface. This tends to consume a large footprint on the semiconductor. Vertical semiconductor devices, on the other hand, utilize a smaller footprint to achieve the same performance as lateral devices. Vertical semiconductor devices have electrical contacts on both the top surface of the semiconductor and on the bottom surface, or backside, such that electricity flows vertically between the electrical contacts. Thus, GaN and vertical GaN semiconductor devices can be utilized in high power and/or high voltage applications, such as power electronics, to improve performance, and reduce physical size of conventional power electronics.

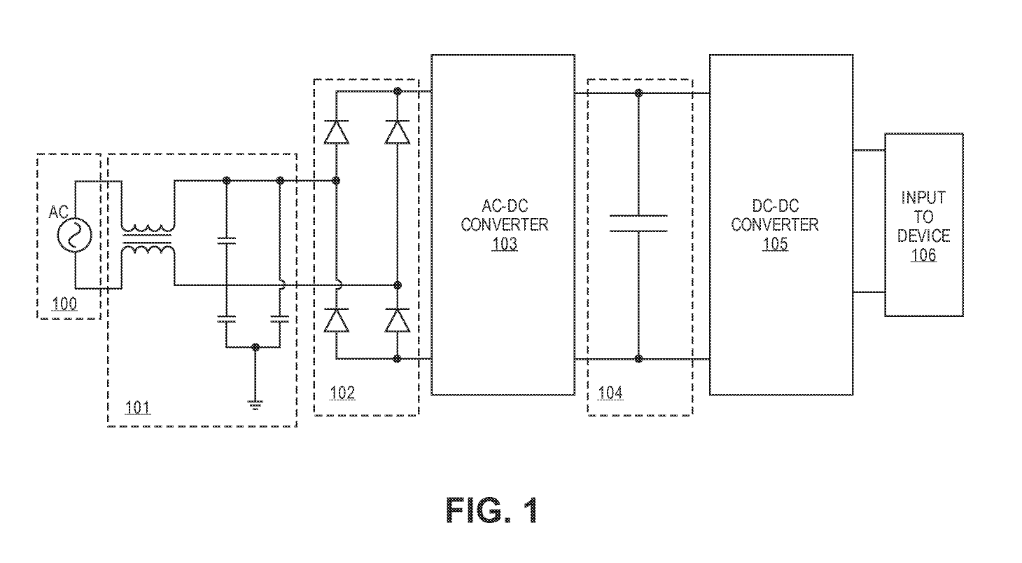

FIG. 1 is a simplified schematic diagram of a power adapter according to an embodiment of this invention. As shown in FIG. 1, the power adapter receives an AC input voltage from an AC power supply 100. Examples of AC power supplies include typical household outlets into which consumers plug a variety of devices, appliances, and household items (e.g., lamp) to receive electricity. Typically, electrical outlet deliver AC power between the range of 90V-265V depending on the country, as different countries provide different standard AC voltage in their electrical outlets.

The AC voltage from AC power supply 100 is then fed to an electromagnetic interference (EMI) filter stage 101. Electromagnetic interference (also called radio frequency interference or RFI when in high frequency or radio frequency) is disturbance that affects an electrical circuit due to either electromagnetic induction or electromagnetic radiation emitted from an external source. EMI may interrupt, obstruct, or otherwise degrade or limit the effective performance of the circuit. Effects of EMI can range from a simple degradation of data to a total loss of data; therefore embodiments of the invention provide an EMI filter to reduce the effects of EMI in the power adapter. The EMI filtered AC input may then be rectified by a full-wave rectifier circuit, converting the filtered AC voltage into a rectified AC voltage. In an embodiment of the present invention, a bridge circuit 102 may be used as the full-wave rectifier circuit.

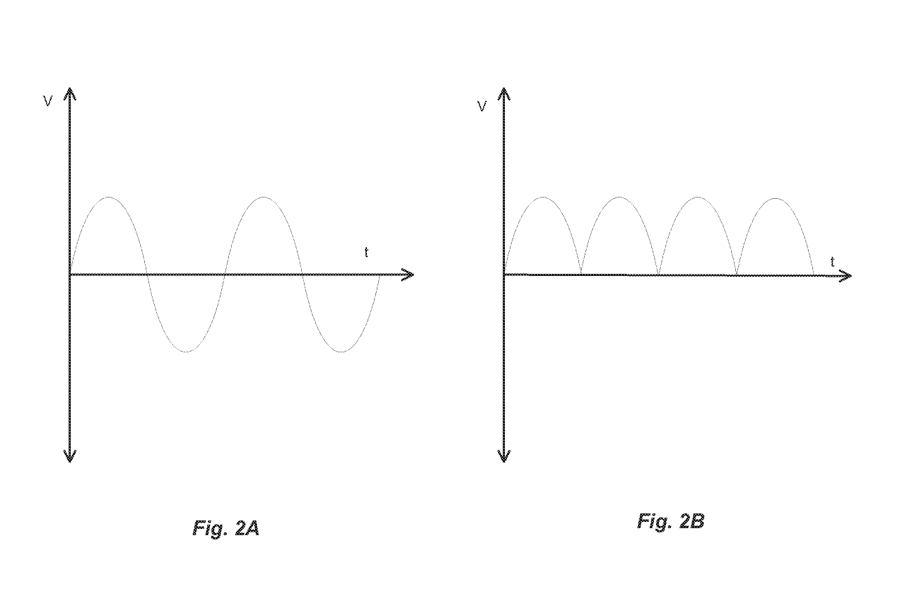

Referring to FIGS. 2A-2B, an exemplary AC input voltage is shown in FIG. 2A as a full sine wave of voltage across time. A full-wave rectifier converts the whole of the input waveform to one of constant polarity (positive or negative) at its output, as shown in FIG. 2B. Full-wave rectification includes converting both polarities of the input AC waveform (e.g., sine wave of FIG. 2A) to DC (direct current), and yields a higher mean output voltage. There are several exemplary full-wave rectifier circuits, such as using two diodes and a center-tapped transformer, or four diodes in a bridge circuit (as shown in FIG. 1) and any AC source (including a transformer without center tap). Single semiconductor diodes, double diodes with common cathode or common anode, and four-diode bridges, may be manufactured as single components.

For single-phase AC, if the transformer is center-tapped, then two diodes back-to-back (cathode-to-cathode or anode-to-anode, depending upon output polarity utilized) may form a full-wave rectifier. Twice as many turns are utilized on the transformer secondary to obtain the same output voltage than for a bridge rectifier, but the power rating is unchanged.

The rectified AC voltage (FIG. 2B) is then converted to DC voltage using an AC/DC converter 103. The rectified AC voltage (FIG. 2B) may be boosted up to a DC voltage as high as 400V according to an embodiment of the present invention, but may be different based on design requirements and applications. The DC voltage from the AC/DC converter 103 is then stored in a hold-up capacitor C_{AC/DC} 104, which may be sized appropriately to satisfy a hold-up time specification. Typical hold-up time specifications are usually half an AC sine wave cycle. The DC voltage across capacitor 104 may then be converted to a lower DC voltage appropriate for its particular application, using a DC/DC converter circuit 105. In typical applications, the DC/DC converter circuit 105 converts the higher DC voltage (e.g., 400V) across the capacitor 104 down to a lower voltage, such as 19V, but could be as high as 25V or as low as 12V depending on its particular application (e.g., device to be powered or charged). The converted, lowered DC voltage from Dc/DC converter 105 (e.g., 19V, 90 W) may then be delivered to an input of a device 106, such as a laptop or other electronic device.

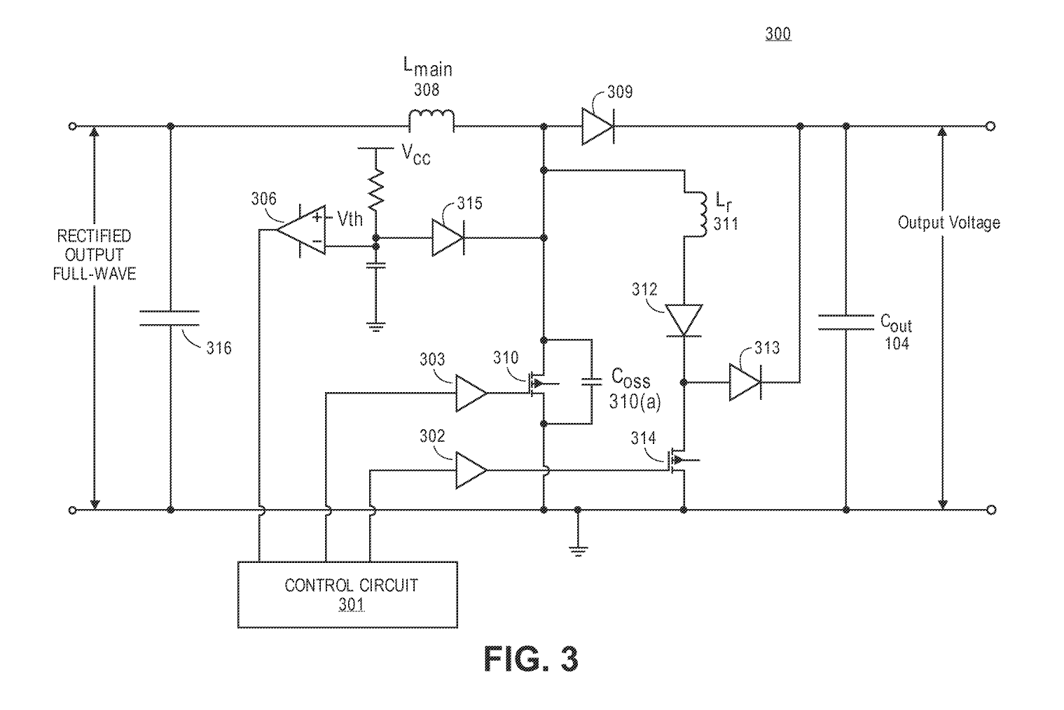

FIG. 3 is a simplified schematic of an exemplary AC/DC converter 300 according to an embodiment of the present invention. In an embodiment of the present invention, a soft-switching boost converter circuit may be used as the AC/DC converter 103 illustrated in FIG. 1. The soft-switching boost converter circuit can include a power-factor correction (PFC) pre-regulation circuit as part of the AC/DC converter 103. The power factor of an AC electrical power system is defined as the ratio of a real power flowing to a load to an apparent power in the circuit, and is a dimensionless number between 0 and 1. Real power is the capacity of the circuit for performing work in a particular time. Apparent power is the product of the current and voltage of the circuit. Due to energy stored in the load and returned to the source, or due to a non-linear load that distorts the wave shape of the current drawn from the source, the apparent power may be greater than the real power.

In typical electric power systems, a load with a low power factor draws more current than a load with a high power factor for the same amount of useful power transferred. High currents increase the energy lost in the system, and require larger wires and other equipment. PFC may involve using a passive network of capacitors and/or inductors to correct linear loads with low power factors. For non-linear loads, such as rectifiers, PFC involves distorting the current drawn from the system. In such cases, active or passive PFC may be used to counteract the distortion and raise the power factor. PFC devices or circuits to correct the power factor may be at a central substation, spread out over the power supply system, or built into power-consuming equipment, depending on the application.

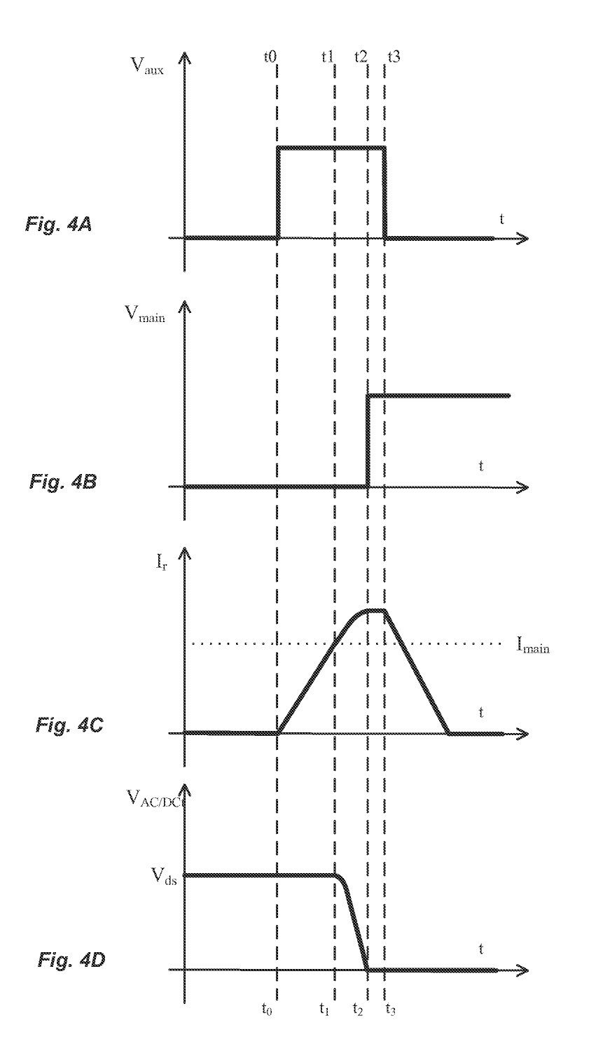

Similar to typical boost PFC pre- regulation, the soft-switching boost converter circuit 300 may comprise a control circuit 301 that regulates an input current (i.e., current through inductor Lₘₐᵢₙ 308) waveform to follow the rectified AC input voltage, while maintaining the DC voltage between DC-link nodes. An auxiliary circuit may be added to the circuit for soft-switching transitions of a main circuit comprising a main transistor 310 and diode 309. In an embodiment of the invention, the auxiliary circuit may include an auxiliary transistor 314, two diodes 312 and 313, and an inductor Lᵣ 311. The auxiliary circuit is active only briefly to facilitate a turn-on transition of the main transistor 310, as illustrated in FIGS. 4A-4D.

FIGS. 4A-4D are simplified waveforms illustrating operation of the auxiliary and main transistors of FIG. 3. The control circuit 301 provides an input voltage to the auxiliary transistor 314. FIG. 4A is a waveform illustrating the input voltage to the auxiliary transistor 314. FIG. 4B illustrates an input voltage to the main transistor 310. FIG. 4C is a waveform illustrating a current, Iᵣ, through Lᵣ. FIG. 4D illustrates the drain to source voltage across the main transistor.

Referring to FIGS. 4A-B, at time prior to t₀, both the main transistor 310 and the auxiliary transistor 314 are in the off-state. The diode 309 conducts the inductor Lₘₐᵢₙ 308 current. At time between t₀ and t₁, the auxiliary transistor 314 is turned on, as shown in FIG. 4A. Current through inductor Lᵣ then increases with a rate approximately at V_{DC-link}/Lᵣ, where the V_{DC-link} voltage represents the output voltage of the boost converter, as shown in FIG. 4C representing current, Iᵣ, through Lᵣ 311. At time t₁, the inductor current Iᵣ, through Lᵣ 311, reaches the current Iₘₐᵢₙ, through the main inductor, Lₘₐᵢₙ 308. Accordingly, the diode 309 is then turned off, all the current Iₘₐᵢₙ, through the main inductor, Lₘₐᵢₙ 308, flows through Lᵣ 311, and not through diode 309.

Between time t₁ and t₂ after the diode 309 is turned off, the inductor, Lᵣ, resonates with the capacitance 310(), Cₒₛₛ, between a drain and a source terminals of the main transistor 310. The voltage across capacitance 310(a) Cₒₛₛ which is monitored by a comparator 306, then falls to a threshold level, Vₜₕ at time t₂. The main transistor 310 is then turned on at time t₂, as shown in FIG. 4B. This represents zero voltage switching as the drain to source voltage across the main transistor is now zero before the transistor is turned on again at time t2. As a result there is no overlap of current and voltage which would otherwise result in significant switching loss and reduce the efficiency of operation of the circuit.

At time between t₂ and t₃, a time delay is introduced before turning off the auxiliary transistor, 314, at t₃ after the main transistor 310 is turned on at t₂, as shown in FIGS. 4A-4B. After the auxiliary transistor 314 is turned off, the inductor current Iᵣ, through Lᵣ 311, then flows through diodes 312 and 313 to the output hold-up capacitor C_{AC/DC} 104. Both diodes 312 and 313 are turned off when the inductor current Iᵣ reaches zero ampere level. This represents one charge cycle of the output capacitor Cₒᵤₜ 104.

In an embodiment of the present invention, a frequency of operation of the soft-switching boost circuit of AC/DC converter 300, shown in FIG. 3 may be higher than 1 MHz. In some embodiments of the present invention, the frequency of operation may be closer to 2 MHz or higher in order to be able to shrink the size of the boost inductor Lₘₐᵢₙ to achieve a target power density of greater than 50 W/in³ for the power adapter. Thus, embodiments of the present invention provide power supplies including AC/DC converters that operate at a frequency ranging from about 0.5 MHz to about 5 MHz. As a particular example, the operating frequency of the AC/DC converter is at a frequency higher than 1.5 MHz.

The main transistor 310 and auxiliary transistor 314 may be a silicon (Si) transistor, a GaN transistor or a silicon-carbide (SiC) transistor, and either in normally-off or normally-on operation. However, it is commonly known to one of ordinary skill in the art that switching a Si transistor at such high frequencies leads to high switching losses, owing to a large input and output capacitance of Si transistors. SiC or GaN transistors are capable of having much smaller switching and transition losses compared to Si transistors, which is advantageous for high frequency operation. Gate drivers 302, 303 are driven by signals from the control circuit 300 and may be customized per the kind of transistor being driven, either normally-off or normally-on.

Similarly, diodes 309, 312 and 313 may also be Si, SiC or GaN diodes. However, for the high switching frequency operations of the soft-switching boost circuit 103 to achieve the target power density of greater than 50 W/in³, Si diodes are susceptible to reverse recovery losses. Therefore, according to an embodiment of the present invention, GaN and/or SiC diodes are used in the soft-switching boost circuit of the AC/DC converter, because GaN and SiC diodes do not suffer from reverse recovery losses that are common to Si diodes. Furthermore, simulations indicate the operational efficiency of the soft-switching boost circuit shown in FIG. 3 using GaN and/or SiC transistors and diodes range from 96% to 98% between full load and 50% load.

Other AC/DC converter circuit topologies other than the soft-switching boost converter circuit 300 of FIG. 3 may also be used for high frequency operation. However, using either SiC or GaN transistors and SiC or Gan diodes in the AC/DC converter circuit according to embodiments of the present invention, achieves increased power density (e.g., greater than 50 W/in³), reduces the physical size of the power adapter, that cannot be achieved through using conventional Si transistors and Si devices.

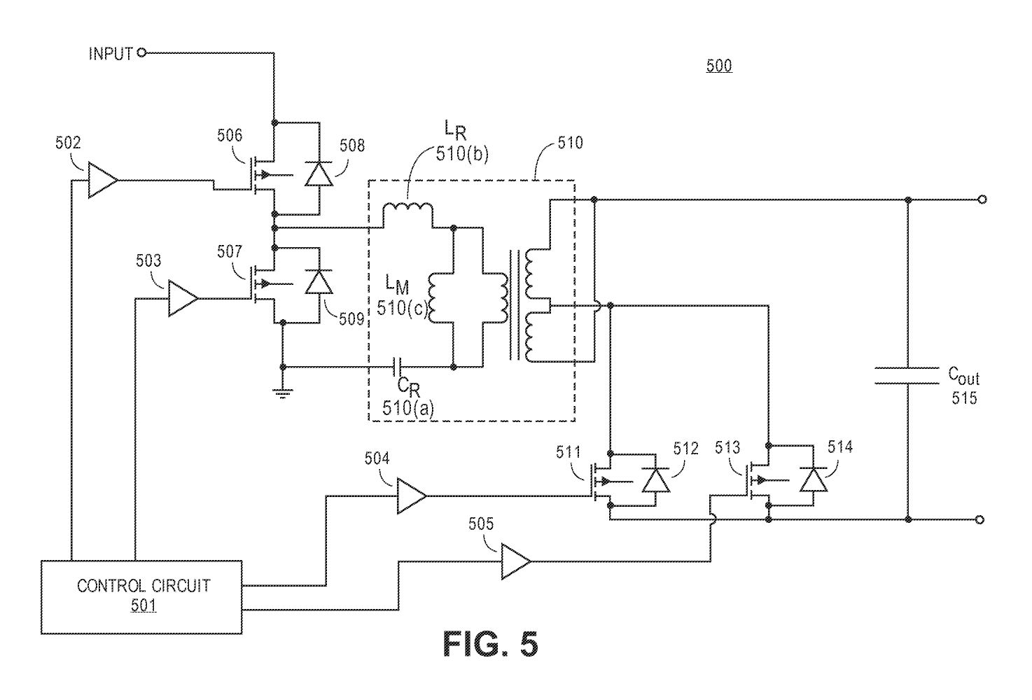

FIG. 5 is a simplified schematic diagram of an exemplary DC/DC converter 500 according to an embodiment of the present invention. As shown in FIG. 1, the DC output voltage from the output capacitor C_{AC/DC} 104 is converted in a DC/DC converter circuit 105, so that a higher DC voltage (e.g., 400V DC output) from the output capacitor C_{AC/DC} 104 may be converted to a usable 19V input to an electronic device, such as a laptop. According to an embodiment of the present invention, a half-bridge LLC (inductor-inductor-capacitor) resonant converter circuit may be used in the DC/DC converter 105 to step down a higher voltage from the DC-link voltage level (i.e., DC output from AC/DC converter) to a lower target output voltage (e.g., 19V for laptop adapter). The half-bridge LLC topology provides high efficiency and high power density. The half bridge LLC circuit according to an embodiment of the present invention consists of three components: a half-bridge network, a resonant network, and rectifier network.

A half-bridge network according to an embodiment of the present invention generates a square wave voltage from an input voltage from the output voltage of the AC/DC converter 103 stored across capacitor C_{AC/DC} 104. The half-bridge network may include the same type (N-Channel) transistors. The first transistor 506 and the second transistor 507 may be driven at 50% duty cycle. Diodes 508 and 509 may be antiparallel to transistors 506 and 507, respectively, such that diode 508 is parallel to transistor 506, but in reverse polarity, and diode 509 is parallel to transistor 507, but in reverse polarity. Antiparallel diodes aid in ensuring safe operating conditions for the transistors by handling currents forced by inductive loads when the transistors are turned off.

A resonant network 510, may consist of a leakage inductor L_{R} 510(b), a magnetizing inductor L_{M} 510(c), and a capacitor C_{R} 510(a). In an embodiment of the invention, the resonant network 510 is an LLC (inductor-inductor-capacitor) circuit, as shown by leakage inductor L_{R} 510(b), a magnetizing inductor L_{M} 510(c), and a capacitor C_{R} 510(a). However, other types of resonant networks are available, for example LLCC, LC, or RLC (resistor-inductor-capacitor). Only AC current flows through the resonant network 510, and is operated such that an input current into the resonant network 510 lags the input voltage to the half-bridge network, which is the output voltage of the AC/DC converter 103 stored across capacitor C_{AC/DC} 104. As a result, the transistors 506 with zero-voltage transitions.

A rectifier network according to embodiment of the present invention may comprise transistors 511 and 513, and antiparallel diodes 512 and 514. The rectifier network converts the AC current from the resonant network 510 into a DC output voltage.

The transistors 506, 507, 511, and 513, and the diodes 508, 509, 512, and 514 may be either GaN or SiC, and normally-on or normally-off according to an embodiment of the present invention in order to achieve a power density range of the power adapter of 35 W/in³ to 80 W/in³. Further, using GaN or SiC transistors and GaN or SiC diodes in the DC/DC converter enables the DC/DC converter 105 to switch at high frequencies of greater than 1.5 MHz so that the resonant network 510 may be physically smaller in size. Typically inductors and capacitors are relatively large, causing increases in the physical size of resonant networks that comprise multiple inductors. The control circuit 501, which drives the transistor drivers 502, 503, 504, and 505, operates at high frequencies. Furthermore, the transistor drivers 502, 503, 504, and 505 may be modified to drive either normally-on or normally-off transistors, depending on their corresponding transistors.

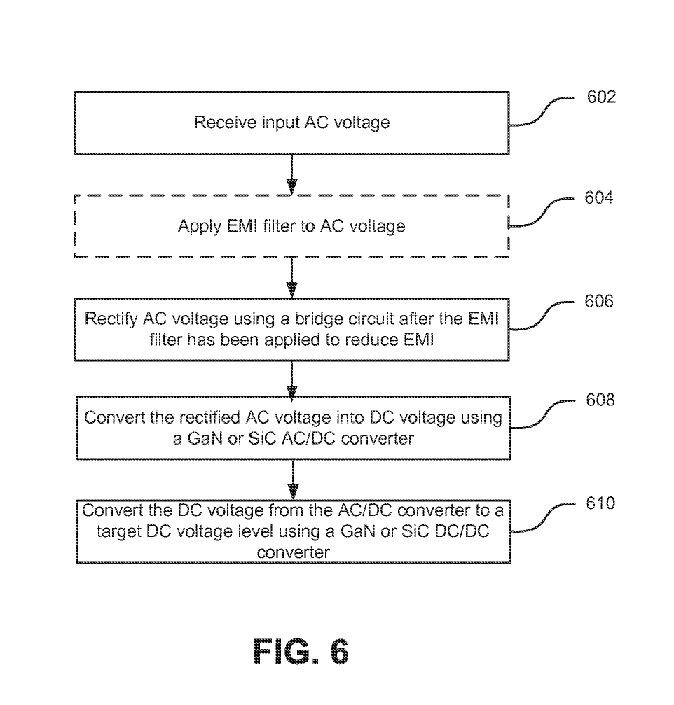

FIG. 6 illustrates an exemplary method of providing DC power at a target power density and target voltage level according to an embodiment of the present invention. The method includes, receiving an input AC voltage (602). In some embodiments, in order to reduce EMI, an EMI filter is applied to the AC voltage (604). The method further includes rectifying the AC voltage with a rectifier circuit, for example, a bridge circuit, after the EMI filter has been optionally applied to the AC voltage (606). Next, the rectified AC voltage is then converted in DC voltage using a GaN or SiC AC/DC converter circuit (608). According to an embodiment of the present invention, the AC/DC converter circuit includes at least one of SiC or GaN transistors and/or SiC or GaN diodes. In some embodiments, the output DC voltage of the SiC or GaN AC/DC converter may be charged to and stored in a holding capacitor.

The method further includes converting the DC voltage from the SiC or GaN AC/DC converter to a target DC voltage using a GaN or SiC DC/DC converter circuit (610). The DC voltage from the SiC or GaN AC/DC converter may be higher than the target DC voltage, for example, the DC target voltage from the SiC or GaN AC/DC converter may be 400V, which may not be appropriate for a particular application. Therefore, the target DC voltage may be delivered at a target DC voltage level (e.g., 19V) and a target power density range (e.g., 35 W/in³ to 80 W/in³), and in an embodiment of the present invention, a target power density may be greater than 50 W/in³.

It should be appreciated that the specific steps illustrated in FIG. 6 provide a particular method of converting AC to DC power, particularly to a very high power density using a power adapter according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A power supply comprising:
a filter stage configured to receive an AC input voltage;
a bridge circuit configured to rectify the filtered AC input voltage;
an AC/DC converter including a primary transistor and an auxiliary circuit including an auxiliary transistor and configured to convert the rectified AC input voltage to a first DC output voltage, wherein the primary transistor and the auxiliary transistor are at least one of gallium nitride (GaN) transistors or silicon carbide (SiC) transistors;
a DC/DC converter configured to convert the first DC output voltage to a second DC output voltage.

2. The power supply of claim 1 wherein the AC/DC converter comprises at least one of SiC or GaN diodes.

3. The power supply of claim 1 wherein the second DC output voltage is delivered at a power density ranging from about 35 W/in³ to about 80 W/in³.

4. The power supply of claim 3 wherein the power density is at least 50 W/in³.

5. The power supply of claim 1 wherein the DC/DC converter comprises:
a half bridge network including a pair of transistors, each transistor having an antiparallel diode;
a resonant network including a leakage inductor, a magnetizing inductor, and a capacitor, wherein the resonant network is configured to turn on the pair of transistors in the half bridge network with predetermined voltage transitions and generate an AC current; and
a rectifier network configured to convert the AC current from the resonant network into the second DC output voltage.

6. The power supply of claim 5 wherein the predetermined voltage transitions are zero-voltage transitions.

7. The power supply of claim 6 wherein the antiparallel diodes in the DC/DC converter are at least one of SiC or GaN diodes.

8. The power supply of claim 7 wherein the power supply/operates at a frequency ranging from about 0.5 MHz to about 5 MHz.

9. The power supply of claim 5 wherein the pair of transistors in the DC/DC converter are at least one of SiC or GaN transistors.

10. The power supply of claim 1, wherein the AC/DC converter operates at a frequency higher than 1.5 MHz.

11. The power supply of claim 1 wherein the DC/DC converter comprises a control circuit configured to drive the half bridge network and the rectifier network.

12. The power supply of claim 1 wherein the AC/DC converter comprises a control circuit configured to drive the primary and auxiliary transistors.

13. A method of providing a DC voltage, the method comprising:
receiving an AC input voltage;
filtering the AC input voltage using an electromagnetic interference (EMI) filter;
rectifying the filtered AC input voltage;
converting the rectified AC input voltage to a first DC output voltage using an AC/DC converter comprising a primary transistor and an auxiliary circuit, wherein the auxiliary circuit comprises an auxiliary transistor and wherein the primary transistor and the auxiliary transistor are at least one of gallium nitride (GaN) or silicon carbide (SiC) transistors; and
converting the first DC output voltage to a second DC output voltage using a DC/DC converter.

14. The method of claim 13 wherein the AC/DC converter comprises at least one of SiC or GaN diodes.

15. The method of claim 13 wherein the second DC output voltage is delivered at a power density of about 35 W/in³ to about 80 W/in³.

16. The method of claim 15 wherein the power density is at least 50 W/in³.

17. The method of claim 13 wherein the DC/DC converter comprises:
a half bridge network including a pair of transistors, each transistor having an antiparallel diode;
a resonant network including a leakage inductor, a magnetizing inductor, and a capacitor, wherein the resonant network is configured to turn on the pair of transistors in the half bridge network with predetermined voltage transitions and generate an AC current; and
a rectifier network configured to convert the AC current from the resonant network into the second DC output voltage.

18. The method of claim 17 wherein the predetermined voltage transitions are zero-voltage transitions.

19. The method of claim 17 wherein the pair of transistors in the DC/DC converter are at least one of SiC or GaN transistors.

20. The method of claim 19 wherein the antiparallel diodes in the DC/DC converter are at least one of SiC or GaN diodes.

21. The method of claim 13 wherein the power supply operates at a frequency ranging from about 0.5 MHz to about 5 MHz.

22. The method of claim 21 wherein the frequency is higher than 1.5 MHz.

23. The method of claim 13 wherein the DC/DC converter comprises a control circuit configured to drive the half bridge network and the rectifier network.

24. The method of claim 13 wherein the AC/DC converter comprises a control circuit configured to drive the primary and auxiliary transistors.
